(19) United States
(12) Patent Application Publication
(10) Pub. No.: US 2024/0403938 A1
(43) Pub. Date: Dec. 5, 2024

(54) Predicting Replacement Items using a Machine-Learning Replacement Model

(71) Applicant: Maplebear Inc. (dba Instacart), San Francisco, CA (US)

(72) Inventors: Tilman Drerup, Palo Alto, CA (US); Shishir Kumar Prasad, Fremont, CA (US); Zoheb Hajiyani, Dublin, CA (US); Luis Manrique, Yucca Valley, CA (US)

(21) Appl. No.: 18/326,900

(22) Filed: May 31, 2023

(51) Int. Cl. G06Q 30/0601; G06N 20/00

(52) U.S. Cl. CPC G06Q 30/0631; G06N 20/00

(57) ABSTRACT

An online system predicts replacement items for presentation to a user using a machine-learning model. The online system receives interaction data describing a user's interaction with the online system. In particular, the interaction data describes an initial item that the user added to their item list. The online system identifies a set of candidate items that could be presented to the user as potential replacements for the initially-added item. The online system applies a replacement prediction model to each of these candidate items to generate a replacement score for the candidate items. The online system selects a proposed replacement item and transmits that item to the user's client device for display to the user. If the user selects the proposed replacement item, the online concierge system replaces the initial item with the proposed replacement item in the user's item list.

### BACKGROUND

Online systems present content to a user with which the user interacts. For example, an online concierge system presents items to a user for the user to add to an order. Online systems may try to predict what content a user would be most interested in interacting with and present content with the highest likelihood of interaction by the user. However, online systems generally limit the information they use for selecting content to information on actions that occurred before the user interaction with the content. For example, a video streaming platform may consider information on which videos a user has watched in the past to determine whether a user would be interested in a particular video. However, while a user's historical interactions may indicate what a user tends to be interested in, it does not directly identify a user's interests. Thus, online systems that solely use historical interaction information by a user tend to be ineffective at selecting content based on a user's current interests.

### SUMMARY

In accordance with one or more aspects of the disclosure, an online system predicts replacement items for presentation to a user using a machine-learning model. The online system receives interaction data describing a user's interaction with the online system. In particular, the interaction data describes an initial item that the user added to their item list. The online system identifies a set of candidate items that could be presented to the user as potential replacements for the initially-added item. The online system applies a replacement prediction model to each of these candidate items to generate a replacement score for the candidate items. The replacement prediction model is a machine-learning model that is trained to predict a likelihood that a user will pick a candidate item as a replacement for another item. This model is trained based on a set of training examples, which may be generated based on instances where a user is presented with a replacement item and does or does not choose to replace an item with the replacement item.

The online system selects a proposed replacement item and transmits that item to the user's client device for display to the user. The proposed replacement item may be displayed to the user after the user has added the initial item to their item list or as the user is finalizing their item list for their order. If the user selects the proposed replacement item, the online concierge system replaces the initial item with the proposed replacement item in the user's item list.

By proposing replacement items for items that the user has already added to their item list, the online system has a much stronger signal for what content the user wants to interact with. Thus, the online system can increase user interaction with content and improve the user experience. Furthermore, by using a replacement prediction model, the online system improves the likelihood that a user will interact with the proposed replacement item.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart for a method of predicting replacements for items added to an item list using a replacement prediction model, in accordance with one or more embodiments.

FIG. 4 illustrates an example user interface presenting proposed replacement items for an initial item that was added to the user's item list, in accordance with one or more embodiments.

### DETAILED DESCRIPTION

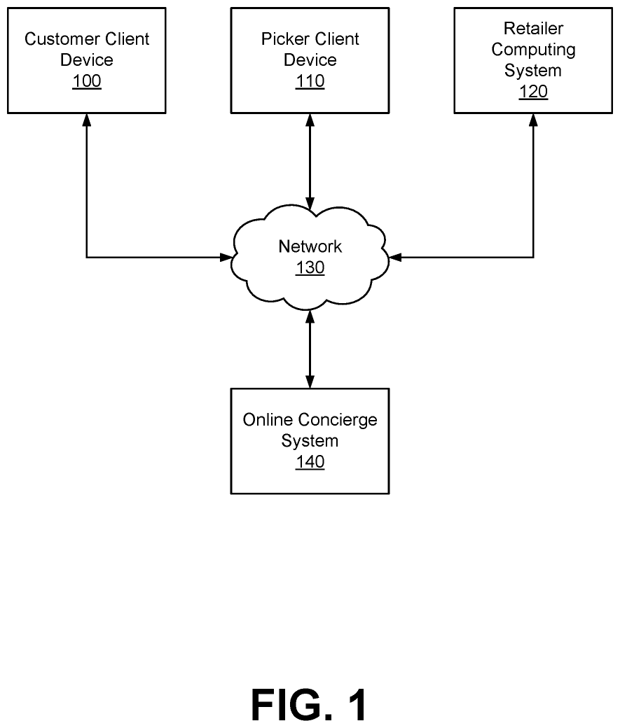

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, so that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

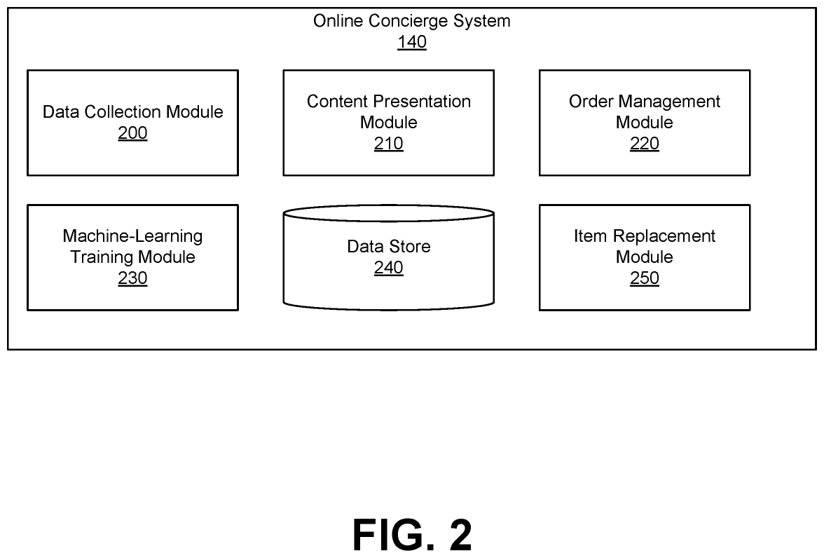

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, a data store 240, and an item replacement module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of the order. In some embodiments, the order management module 220 computes an estimated time of arrival of the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

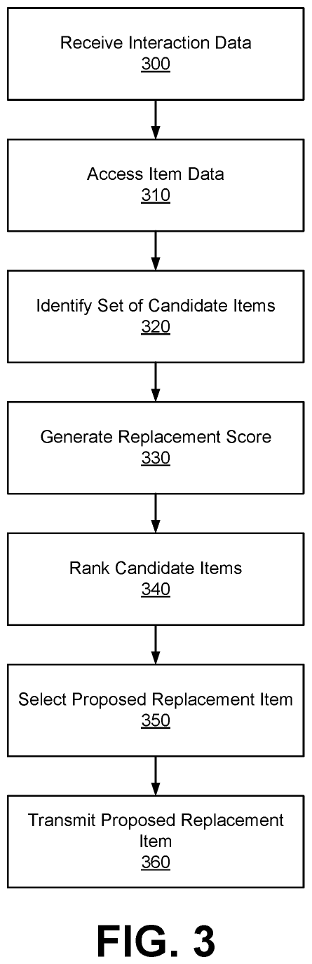

The item replacement module 250 predicts replacements for items added to a user's item list. The item replacement module 250 uses a replacement prediction model to generate replacement scores for candidate items. These candidate items are potential replacements for an item already added to the user's item list. The candidate items are ranked based on their replacement scores and a potential replacement item is transmitted to the user's client device to display the potential replacement item to the user. FIG. 3 describes an example method that may be performed by the item replacement module 250, in accordance with some embodiments.

FIG. 3 is a flowchart for a method of predicting replacements for items added to an item list using a replacement prediction model, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

An online concierge system receives 300 interaction data from a user's client device. This interaction data describes interactions of the corresponding user with the online system through the client device (e.g., through a corresponding client application operating on the client device). In particular, the interaction data describes an item that a user has added to an item list (i.e., their shopping list), which is a list of items that the user has tentatively selected for an order they have yet to place. The interaction data may also describe other interactions of the user with the online concierge system. For example, the interaction data may describe the user selecting an item to view more information on the item or search queries placed by the user.

The online concierge system accesses 310 item data for the item that the user added to their item list. Item data is information or data that describes or identifies items available on the online concierge system. For example, item data may describe attributes of items, such as the size, color, weight, stock keeping unit (SKU), or serial number for the item.

The online concierge system identifies 320 a set of candidate items to be considered as possible replacements for the initial item added by the user to their item list. These candidate items are other items available at the same retailer from which the user is ordering items. To identify the candidate items, the online concierge system may identify a subset of the full set of items available at the retailer that have some threshold similarity to the initial item. For example, the online concierge system may identify candidate items that are a common category to the initial item or that are within a common sub-branch of an item taxonomy that the online concierge system uses to categorize items. Alternatively, the online concierge system compares embeddings describing items available at a retailer to an embedding describing the initial item and identifies candidate items whose embeddings are some threshold maximum distance to the initial item's embedding.

In some embodiments, the online concierge system identifies the set of candidate items by applying a set of filtering rules to items that are available at a retailer. For example, the online concierge system may apply a rule that requires that candidate items be items for which the online concierge system is offering a promotional price or quantity. Another example rule is one that candidate items be ones for which the online concierge system has received consideration from the retailer or a manufacturer to present as recommended items. In some cases, the rules require that candidate items be ones that are particularly popular or are less expensive than the initial item.

The online concierge system generates 330 a replacement score for each of the candidate items. A replacement score for a candidate item is a score that represents a likelihood that the user will replace the initially added item with the candidate item. The online concierge system generates the replacement score for a candidate item based on item data describing the initial item and item data describing the candidate item. The online concierge system also may generate the replacement score based on user data describing characteristics of the user or context data describing the user's current session with the online concierge system.

The online concierge system generates the replacement scores by applying a replacement prediction model to the item data for the initial item and the candidate item. A replacement prediction model is a machine-learning model (e.g., a neural network) that is trained to predict a likelihood that a user will replace one item with another based on the item data of the items. The replacement prediction model is trained based on a set of training examples. Each of these training examples includes item data for an item to be replaced, item data for a candidate replacement item, and a label indicating whether the item to be replaced would be selected by a user for replacement with the candidate replacement item. The set of training examples may be hand-labeled or may be automatically generated by the online concierge system. For example, the online concierge system may present a candidate replacement item as a replacement for an already-selected item and generate a label for a training example with those two items based on whether the user replaced the selected item with the candidate replacement item. As noted above, the replacement prediction model may be applied to user data for the user or context data for the user's session. In some embodiments, the replacement prediction model is also a model that the online concierge system uses for predicting ideal replacements for out-of-stock items for a user.

In some embodiments, the replacement score for a candidate item represents a likelihood that a user will complete the order with the item list if the initial item is replaced with the candidate item. In these embodiments, the replacement prediction model is trained using training examples generated based on users placing orders with the online concierge system. For example, the online concierge system may present a candidate item as a replacement for an item that a user has added to their item list. The online concierge system may then track whether the user adds the candidate item as a replacement for the initially-added item, and label a training example based on the two items with whether the user placed the eventual order with the online concierge system. Thus, the replacement prediction model may be trained based on training examples labeled with the conversion of the candidate item or conversion of the shopping list as a whole.

The online concierge system ranks 340 the candidate items based on the generated replacement scores. The online concierge system may simply rank the items in accordance with their replacement scores. Alternatively, the online concierge system may combine the replacement scores with other metrics for the item and rank the candidate items based on the combined scores. For example, the online concierge system may also consider how much net consideration the retailer or the online concierge system will receive if the user orders the candidate item. Similarly, where candidate items are sponsored by a retailer or a manufacturer, the online concierge system may also consider an amount of consideration offered by the retailer or manufacturer to present the candidate item as a recommendation to the user.

The online concierge system selects 350 a proposed replacement item based on the ranking and transmits 360 the proposed replacement item to the client device for display to the user. In some embodiments, the online concierge system selects multiple replacement items to transmit to the client device. In these embodiments, the online concierge system may select the top n candidate items or may select all candidate items that have replacement scores that exceed some threshold.

The client device displays the proposed replacement item as a replacement for the initial item that the user added to their item list. For example, the client device may display the proposed replacement item on a confirmation page that the user successfully added the initial item to their item list or may display the proposed replacement item as part of an order confirmation page while the user is finalizing their order. If the user selects the proposed replacement item, the online concierge system replaces the initial item in the item list with the proposed replacement item.

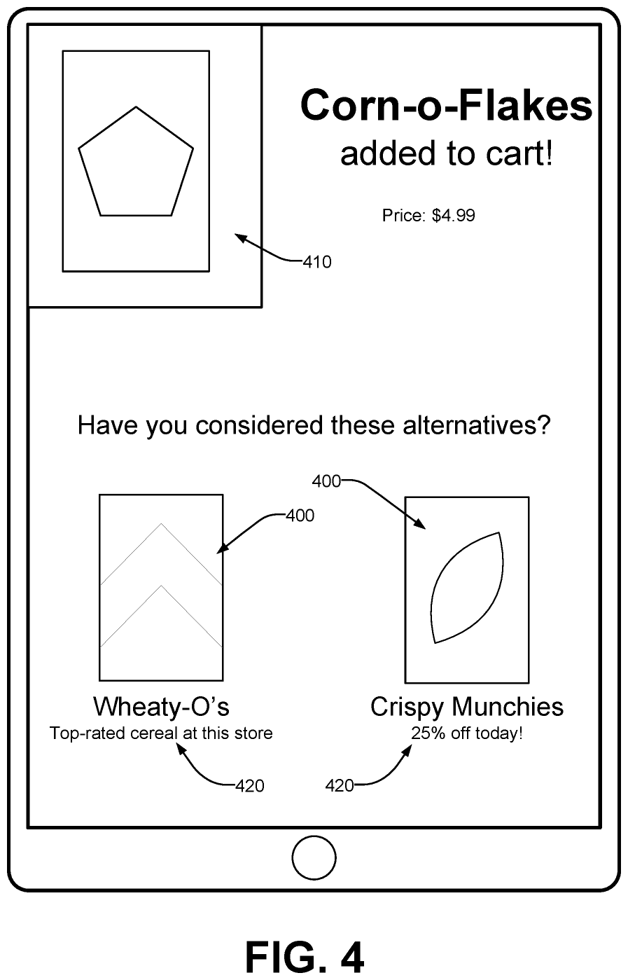

FIG. 4 illustrates an example user interface presenting proposed replacement items 400 for an initial item 410 that was added to the user's item list, in accordance with some embodiments. As illustrated in FIG. 4, the replacement items 400 may be presented along with explanations 420 for why the replacement items might be desirable to the user. If the user selects the user interface element for a proposed replacement item 400, the online concierge system replacements the initial item 410 in the user's item list with the proposed replacement item 400 corresponding to the selected user interface element.

While the description above primarily describes the method for predicting replacement items in the context of a user placing an order with an online concierge system, an online system may display proposed replacement items to a user through a display of a smart shopping cart. The online system may detect that a user has added an item to a storage area of the shopping cart and identify the added item. The online system may identify candidate items for that added item and generate replacement scores for each of the candidate items using a prediction replacement model. In some embodiments, the online system identifies items that are near the shopping cart as candidate items for possibly replacing the added item. For example, the online system may determine the location of a shopping cart based on sensor data from the shopping cart and use a map of items (e.g., a planogram) for the retailer location to determine which items are near the user. The online system may use these item nearby items as candidate items for the proposed replacement item. The online system selects one of the candidate items as a proposed replacement item based on the replacement scores and transmits the proposed replacement item to display to the user via the shopping cart.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed by a computer system comprising a processor and a computer-readable medium, comprising:
receiving interaction data from a client device describing an interaction of a user with an online system through the client device, wherein the interaction comprises the user adding an initial item to an item list corresponding to the user;
accessing item data for the initial item from an item database of the online system;
identifying a set of candidate items based on the accessed item data;
generating a replacement score for each of the candidate items by applying a replacement prediction model to the accessed item data and item data for each candidate item of the set of candidate items, wherein replacement score for a candidate item represents a likelihood that the user will replace the initial item with the candidate item in the item list, and wherein the replacement prediction model is a machine-learning model that is trained to predict a likelihood that a user will replace one item with another item in an item list based on item data for both items;
ranking the set of candidate items based on the generated replacement scores;
selecting a proposed replacement item for the initial item based on the ranking; and
transmitting the proposed replacement item to the client device, wherein the transmitting causes the client device to display the proposed replacement item to the user.

2. The method of claim 1, further comprising:
training the replacement prediction model based on a set of training examples, wherein each training example comprises item data for an item to be replaced, item data for a candidate replacement item, and a label indicating whether the candidate replacement item would be selected as a replacement for the item to be replaced.

3. The method of claim 2, wherein training the replacement prediction model comprises:
automatically labeling each of the set of training examples based on whether a user selected the candidate replacement item as a replacement for the item to be replaced.

4. The method of claim 1, wherein receiving the interaction data comprises:
receiving an indication that the user added the initial item to a storage area of a shopping cart.

5. The method of claim 4, wherein transmitting the proposed replacement item comprises:
transmitting the proposed replacement item to the shopping cart for display to the user through a display of the shopping cart.

6. The method of claim 1, wherein identifying the set of candidate items comprises:
applying a filtering rule to a full set of items available at a retailer.

7. The method of claim 1, wherein generating a replacement score for each candidate item comprises:
applying the replacement prediction model to user data describing the user.

8. The method of claim 1, wherein generating a replacement score for each candidate item comprises:
applying the replacement prediction model to context data describing a current session of the user with the online system.

9. The method of claim 1, wherein ranking the set of candidate items comprises:
generating a combined score for each of the candidate items by combining a metric of each candidate item with the corresponding replacement score of the candidate item.

10. The method of claim 1, further comprising:
receiving a user selection of the proposed replacement item; and
responsive to receiving the user selection, replacing the initial item with the proposed replacement item in the item list.

11. A non-transitory computer-readable medium storing instructions that, when executed by a processor, cause the processor to perform operations comprising:
receiving interaction data from a client device describing an interaction of a user with an online system through the client device, wherein the interaction comprises the user adding an initial item to an item list corresponding to the user;
accessing item data for the initial item from an item database of the online system;
identifying a set of candidate items based on the accessed item data;
generating a replacement score for each of the candidate items by applying a replacement prediction model to the accessed item data and item data for each candidate item of the set of candidate items, wherein replacement score for a candidate item represents a likelihood that the user will replace the initial item with the candidate item in the item list, and wherein the replacement prediction model is a machine-learning model that is trained to predict a likelihood that a user will replace one item with another item in an item list based on item data for both items;
ranking the set of candidate items based on the generated replacement scores;
selecting a proposed replacement item for the initial item based on the ranking; and
transmitting the proposed replacement item to the client device, wherein the transmitting causes the client device to display the proposed replacement item to the user.

12. The non-transitory computer-readable medium of claim 11, further storing instructions that, when executed by a processor, cause the processor to perform operations comprising:
training the replacement prediction model based on a set of training examples, wherein each training example comprises item data for an item to be replaced, item data for a candidate replacement item, and a label indicating whether the candidate replacement item would be selected as a replacement for the item to be replaced.

13. The non-transitory computer-readable medium of claim 12, wherein training the replacement prediction model comprises:
automatically labeling each of the set of training examples based on whether a user selected the candidate replacement item as a replacement for the item to be replaced.

14. The non-transitory computer-readable medium of claim 11, wherein receiving the interaction data comprises:
receiving an indication that the user added the initial item to a storage area of a shopping cart.

15. The non-transitory computer-readable medium of claim 14, wherein transmitting the proposed replacement item comprises:
transmitting the proposed replacement item to the shopping cart for display to the user through a display of the shopping cart.

16. The non-transitory computer-readable medium of claim 11, wherein identifying the set of candidate items comprises:
applying a filtering rule to a full set of items available at a retailer.

17. The non-transitory computer-readable medium of claim 11, wherein generating a replacement score for each candidate item comprises:
applying the replacement prediction model to user data describing the user.

18. The non-transitory computer-readable medium of claim 11, wherein generating a replacement score for each candidate item comprises:
applying the replacement prediction model to context data describing a current session of the user with the online system.

19. The non-transitory computer-readable medium of claim 11, wherein ranking the set of candidate items comprises:
generating a combined score for each of the candidate items by combining a metric of each candidate item with the corresponding replacement score of the candidate item.

20. A system comprising a processor and a non-transitory computer-readable medium storing instructions that, when executed by the processor, cause the processor to perform operations comprising:
receiving interaction data from a client device describing an interaction of a user with an online system through the client device, wherein the interaction comprises the user adding an initial item to an item list corresponding to the user;
accessing item data for the initial item from an item database of the online system;
identifying a set of candidate items based on the accessed item data;
generating a replacement score for each of the candidate items by applying a replacement prediction model to the accessed item data and item data for each candidate item of the set of candidate items, wherein replacement score for a candidate item represents a likelihood that the user will replace the initial item with the candidate item in the item list, and wherein the replacement prediction model is a machine-learning model that is trained to predict a likelihood that a user will replace one item with another item in an item list based on item data for both items;
ranking the set of candidate items based on the generated replacement scores;
selecting a proposed replacement item for the initial item based on the ranking; and
transmitting the proposed replacement item to the client device, wherein the transmitting causes the client device to display the proposed replacement item to the user.
